(19) United States
(12) Patent Application Publication
(10) Pub. No.: US 2004/0214929 A1
(43) Pub. Date: Oct. 28, 2004

(54) Rubber composition containing a silica dispersion agent

(76) Inventors: Robert Bradley, Medina, OH (US); Rabin Datta, Deventer (NL)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/630,240

(22) Filed: Jul. 30, 2003

Related U.S. Application Data
(60) Provisional application No. 60/464,988, filed on Apr. 24, 2003.

(51) Int. Cl. C08L 1/00

(52) U.S. Cl. 524/161; 524/493; 524/157; 524/210; 524/495; 524/287; 524/291; 524/571; 525/333.9; 525/331.9; 525/333.3

(57) ABSTRACT

A process for the vulcanization of a rubber composition, and articles of manufacture where the vulcanized rubber comprises the vulcanization reaction product of the vulcanisation process of the invention, are disclosed. The vulcanisation process is carried out on a vulcanizable composition containing a silica dispersion agent of the formulae I-IV. The composition of the present invention allows for the partial or complete replacement of conventional silane coupling agents in silica filled rubber compositions.

### RELATED APPLICATIONS

This application claims the benefit of U.S. provisional application no. 60/464,988, filed on Apr. 24, 2003, under 35 U.S.C. §119(e).

### FIELD OF THE INVENTION

The present invention relates to sulfur-vulcanizable rubber compositions which employ processing aids to improve the dispersion of the reinforcing filler in rubber compounds. More particularly, the present invention is directed to a vulcanizable elastomeric composition containing a silica dispersion agent, a pneumatic tire made from the vulcanizable elastomeric composition and a vulcanisation process employing the silica dispersion agent.

### BACKGROUND OF THE INVENTION

Most rubber compositions contain a reinforcing filler such as carbon black, synthetic amorphous silica-based materials, or combinations of carbon black with silica-based materials, such as light coloured or white filler such as silica or a silicate. Rubber compositions comprising relatively large amounts of a silica or a silicate are well known in the art and pneumatic tires with rubber treads made from such compositions are generally referred to as “green tires”. These rubber compositions typically do not contain a carbon black, or only contain a small amount of a carbon black, typically 5 to 20 phr.

It is well known in the art that the dispersion of silica in rubber, especially in green tire rubber compositions, presents a problem—due to poor interaction between the filler and the rubber and strong filler-filler interaction—and that mixing of silica in rubber is difficult. Also, such mixing consumes a great deal of power and can be time-consuming as well. Further, poor dispersion can result in a high compound viscosity and a shorter scorch time. Poor dispersion of silica in rubber results in inferior physical and dynamic properties of the vulcanizate, in particular increased hysteresis and increased heat build up.

In order to improve silica dispersion, it is conventional to use a coupling agent together with the silica to couple or otherwise enhance its elastomer-reinforcing effect. Such coupling agents are conventionally silane-based compounds which have a silane-based moiety, which is reactive with hydroxyl groups, such as the silanol groups, found on the surface of silica and having another moiety, such as a polysulfide bridge, which may interact with a conjugated diene-based elastomer. Examples of silane-based coupling agents, include bis-(3-triethoxysilylpropyl) tetrasulfide (TESPT), which is available from Degussa as Si-69 organosilane.

Silica and silica coupling agents are typically used in passenger car tire tread. The silica/silane coupling agent system improves the wear of the tire tread (i.e. improves abrasion resistance) and improves the dynamic properties of the rubber vulcanizate; in particular it reduces hysteresis, which can be translated into better rolling resistance, and leads to fuel savings without a negative effect on wet grip.

However, when use is made of known silica coupling agents, the dispersion is still not optimal under standard mixing conditions. Furthermore, as a result of using a silane coupling agent, the reaction between the silane and the hydroxyl groups on the surface of a synthetic amorphous silica results in the release of volatile alcohols (ethanol), which escape from the rubber composition and present an environmental problem. In addition, a reduction of the amount of silica coupling agent is desired, since their use in conventional amounts significantly adds to the cost of the rubber vulcanizate.

In order to avoid the release of volatile alcohols, alternatives to silane coupling agents have been sought. For example, U.S. Pat. No. 6,528,592 to Wideman et al. teaches the use of 2-hydroxyethyl methacrylate, which is a non-silane coupling agent, or a combination of the 2-hydroxyethyl methacrylate with bis(3′-trialkoxysilylalkyl)polysulfide to aid in the reinforcement of the rubber composition with a particulate silica-based material. U.S. Pat. No. 6,458,882 to Pyle et al. teaches the use of tetrathidipropionic acid as a non-silane coupling agent. U.S. Pat. No. 6,476,115 to Wideman et al. teaches N-3-(1,2-dihydroxypropyl)-N-oleyl ammonium bromide or N-3-(1,2-dihydroxypropyl)-N-methyl-2-mercaptoimidazolium bromide as non-silane coupling agents. U.S. patent application publication no. 20020128369 to Wideman et al. teaches the use of 1-thioglycerol(3-mercapto)-1,2-propanediol as a non-silane coupling agent.

Compositions having a long chain alkyl group and either a sulphonic acid or salt, a multihydroxy ester or amine, or a maleic, succinic, or citraconic acid are known. For example, linear alkyl sulfonates, such as sodium dodecylbenzenesulfonate, is such a composition. Linear alkyl sulfonates are used as surfactants or detergents in soaps and cleaning compositions, such as hard surface cleaners. See, for example, U.S. Pat. No. 5,888,960 to Lazorowitz et al. and U.S. Pat. No. 5,837,665 to Young, as well as International patent application publication no. WO 99/00469 to Gross.

### SUMMARY OF THE INVENTION

In a first aspect, the present invention relates to a process for the preparation of a vulcanised elastomeric compound. The process comprises the steps of providing a composition which contains an elastomer, from about 5 to about 100 phr of reinforcing filler, based on the amount of elastomer, from about 0.1 to about 25 phr of sulfur and/or a sufficient amount of sulfur donor to provide the equivalent of 0.1 to 25 phr of sulfur, based on the amount of elastomer, and an effective amount of a silica dispersion agent, wherein the silica dispersion agent is selected from the group consisting of:

a) compounds of the formula I:

R-A-SO₃M (I)

wherein R is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, C₇-C₃₀ alkylthioaryl groups;

A is selected from nothing, a group —O—B—, wherein B is a polyoxyalkylene group wherein the average number of oxyalkylene groups is in the range of from about 0.5 to about 30, and an ester group of the formula:

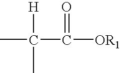

wherein R₁ is a C₁-C₆ hydrocarbyl group; and

M is selected from hydrogen, and a cation selected from an alkali metal, an alkaline earth metal, ammonium, alkyl-substituted ammonium, and an alkanolamime group having 1 to 3 alkanol groups, wherein each alkanol group has 2 or 3 carbon atoms;

b) a polyhydroxy fatty acid amide of the formula II:

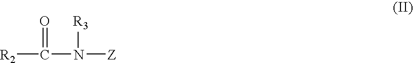

wherein R₂ is selected from hydrogen, C₁-C₁₀ hydrocarbyl, 2-hydroxy ethyl, 2-hydroxy propyl, methoxy ethyl, methoxy propyl or a mixture thereof, R₃ is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, and C₇-C₃₀ alkylthioaryl groups; and Z is a polyhydroxyhydrocarbyl having a linear hydrocarbyl chain with at least three hydroxy groups directly connected to the linear hydrocarbyl chain, or an alkoxylated polyhydroxyhydrocarbyl having a linear hydrocarbyl chain with at least three hydroxy groups directly connected to the linear hydrocarbyl chain; and

c) a compound of the formulae III and IV:

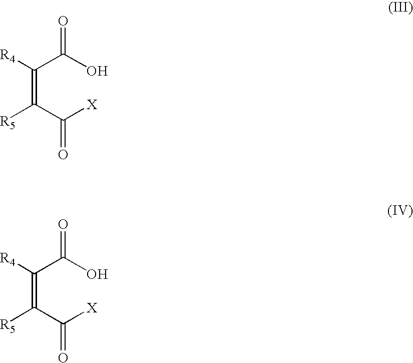

wherein R₄ and R₅ are independently selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, and X is selected from the group consisting of —OH and —NH—R₆, wherein R₆ is selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups; and

vulcanising the composition.

In a second aspect, the present invention relates to the use of an amount of a compound of the formulae I-IV, which is effective as a silica dispersion agent in a process for the sulfur vulcanisation of a filler-reinforced elastomer.

In a third aspect the present invention relates to a vulcanizable composition including:

A) an elastomer;

B) 0.1 to 25 phr of sulfur, based on the elastomer, and/or a sufficient amount of sulfur donor to provide the equivalent of 0.1 to 25 phr of sulfur, based on the elastomer;

C) 5-100 phr of at least one reinforcing filler, based on the amount of elastomer, and

D) an effective amount of a silica dispersion agent of the formula I-IV.

In a fourth aspect, the present invention relates to a vulcanisation product produced by the vulcanisation process of the present invention. In a fifth aspect, the ID present invention relates to a tire, which comprises the vulcanisation product of the present invention.

### DETAILED DESCRIPTION OF THE INVENTION

In the description of this invention, the term “phr” is used to designate parts by weight of a material per 100 (one hundred) parts by weight of elastomer or rubber. The terms “rubber” and “elastomer” are used interchangeably unless otherwise specified. The terms “vulcanized” and “cured” and the terms “unvulcanized” and “uncured,” are also used interchangeably, unless otherwise indicated.

In a first aspect, the present invention relates to a process for the preparation of a sulfur vulcanised elastomeric compound. The process comprises the steps of providing a composition which contains an elastomer, from about 5 to about 100 phr of reinforcing filler, based on the amount of elastomer, from about 0.1 to about 25 phr of sulfur and/or a sufficient amount of sulfur donor to provide the equivalent of 0.1 to 25 phr of sulfur, based on the amount of elastomer, and an effective amount of a silica dispersion agent, wherein the silica dispersion agent is selected from the group consisting of:

a) compounds of the formula I:

R-A-SO₃M (I)

wherein R is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, C₇-C₃₀ alkylthioaryl groups;

A is selected from nothing, a group —O—B, wherein B is a polyoxyalkylene group wherein the average number of oxyalkylene groups is in the range of from about 0.5 to about 30, and an ester group of the formula:

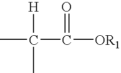

wherein R₁ is a C₁-C₆ hydrocarbyl group; and

M is selected from hydrogen, and a cation selected from an alkali metal, an alkaline earth metal, ammonium, alkyl-substituted ammonium, and an alkanolamine group having 1 to 3 alkanol groups, wherein each alkanol group has 2 or 3 carbon atoms;

b) a polyhydroxy fatty acid amide of the formula II:

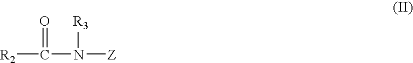

wherein R₂ is selected from hydrogen, C₁-C₁₀ hydrocarbyl, 2-hydroxy ethyl, 2-hydroxy propyl, methoxy ethyl, methoxy propyl or a mixture thereof, R₃ is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, and C₇-C₃₀ alkylthioaryl groups; and Z is a polyhydroxyhydrocarbyl having a linear hydrocarbyl chain with at least three hydroxy groups directly connected to the linear hydrocarbyl chain, or an alkoxylated polyhydroxyhydrocarbyl having a linear hydrocarbyl chain with at least three hydroxy groups directly connected to the linear hydrocarbyl chain; and

b) a compound of the formulae III and IV:

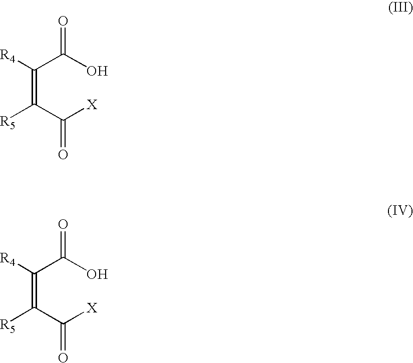

wherein R₄ and R₅ are independently selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, and X is selected from the group consisting of —OH and —NH—R₆, wherein R₆ is selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups; and

vulcanising the composition.

More preferably, the silica dispersion agents of the formula I are selected from linear or branched alkyl benzene sulfonic acids, linear or branched alkyl benzene sulfonates, linear or branched alkyl thiosulfonic acids and linear or branched alkyl thiosulfonates. Exemplary compounds of the formula I useful in the present invention include, but are not limited to, dodecylbenzenesulfonic acid, sodium dodecylbenzene sulfonate, dodecyl thiosulfonic acid, and dodecyl thiosulfonic acid sodium salt.

Exemplary cations M of the formula I include, but are not limited to, sodium, potassium, lithium, calcium, magnesium, ammonium, methyl-ammonium, dimethyl-ammonium, trimethyl-ammonium, tetramethyl-ammonium, dimethyl piperdinium, monoethanolamine, diethanolamine, triethanolamine and mixtures thereof. Preferably, M is selected from sodium, potassium and ammonium.

Preferably, R of the formula I is selected from C₉-C₂₀ linear or branched alkyl groups. Preferably, A of the formula I is nothing.

With respect to silica dispersion agents of the formula II, R₂ is preferably a C₁-C₆ alkyl group, and more preferably R₂ is a methyl or ethyl group. R₃ is preferably a linear C₇-C₂₀ alkyl or alkenyl group, and more preferably a linear C₉-C₂₀ alkyl group. Z is preferably derived from a reducing sugar via a reductive amination reaction. Suitable reducing sugars include, but are not limited to, glucose, fructose, maltose, lactose, galactose, mannose and xylose. As raw materials, high dextrose corn syrup, high fructose corn syrup and high maltose corn syrup can be used, as an alternative to the reducing sugars themselves. Depending on the raw material employed, a mixture of sugar derived components Z may be obtained.

Most preferably, Z is selected from the group consisting of —CH₂—(CHOH)ₙ—CH₂OH, —CH(CH₂OH)—CHOH)ₙ₋₁—CH₂OH, —CH₂—(CHOH)₂—(CHOR′)—(CHOH)—CH₂OH; where n is an integer from 3 to 5, inclusive, and R′ is H or a cyclic or aliphatic monosaccharide, as well as the alkoxylated derivatives thereof. Preferred compounds of the formula II include 2,3,4,5,6 pentahydroxy hexanoic acid octylamide, 2,3,4,5,6 pentahydroxy hexanoic acid octadecylamide and 2,3,4,5,6 pentahydroxy hexanoic acid dodecylamide.

Exemplary compounds of the formulae III and FV include, but are not limited to, N-dodecyl maleic acid, N-octadecyl maleic acid, N-dodecyl-succinic acid, N-octadecyl succinic acid, N-dodecyl citraconic acid and N-octadecyl citraconic acid.

The amount of silica dispersion agent to be compounded with the rubbers, will be in the range of 0.1-25 phr, preferably in the range 0.5-10 phr, and most preferably in the range of 1.0-8.0 phr, based on the elastomer. The silica dispersion agent of the present invention may be used to replace all or at least a portion of a conventional silica coupling agent, such as a silane coupling agent, in sulfur-vulcanisable elastomeric compositions.

The reinforcing fillers that may be used in accordance with the present invention are well known to persons skilled in the art, as is apparent from W. Hofmann, “Rubber Technology Handbook”, Hanser Publishers, Munich 1989, in particular pages 277-294. Preferably, the reinforcing filler is a synthetic amorphous silica selected from aggregates of precipitated silica, including precipitated aluminosilicates, as well as silicas derived from fumed silica. Preferably, the silica reinforcing filler is a high surface area silica or silicate, or a mixture thereof.

The precipitated silica aggregates preferably employed in this invention are precipitated silicas such as, for example, those obtained by the acidification of a soluble silicate, e.g., sodium silicate and may include co-precipitated silica and a minor amount of aluminum. Such silicas might usually be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, Page 304 (1930).

The silica may also be typically characterized by having a dibutylphthalate (DBP) absorption value in a range of about 50 to about 400 cm³/100 g, and more usually about 100 to about 300 cm³/100 g.

Various commercially available precipitated silicas may be considered for use in this invention such as, only for example herein, and without limitation, silicas from PPG Industries under the Hi-Sil trademark with designations Hi-Sil 210, Hi-Sil 243, etc; silicas from Rhodia as, for example, Zeosil 1165 MP and Zeosil 165GR, silicas from Degussa AG with, for example, designations VN2 and VN3, as well as other grades of silica, particularly precipitated silicas, which can be used for elastomer reinforcement.

The reinforcing filler of the present invention may also comprise a silica treated carbon black, i.e. carbon black which contains domains of exposed silica on the surface of the carbon black. Such carbon black may be prepared, for example, by reaction of an alkyl silane with carbon black or by co-fuming carbon black and silica at an elevated temperature. Exemplary processes can be found in, for example, U.S. Pat. Nos. 5,679,728 and 6,028,137.

In addition, the reinforcing filler of the present invention may be formed from a mixture of silica reinforcing filler and/or silica-treated carbon black, optionally containing various forms of carbon black that have not been treated with silica, such as the commercially available carbon blacks. However, carbon blacks having a surface area (EMSA) of at least 20 m²/g up to 200 m²/g or higher, are preferred. Surface areas are determined using ASTM D-1765 using the cetyltrimethylammonium bromide technique. Among the useful carbon blacks are furnace black, channel blacks and lamp blacks. More specifically, useful carbon blacks include super abrasion furnace (SAF) blacks, high abrasion furnace (HAF) blacks, fast extrusion furnace (FEF blacks, fine furnace (FF) blacks, intermediate super abrasion furnace (ISAF) blacks, semi-reinforcing furnace (SRF) blacks, medium processing channel blacks, hard processing channel blacks and conducting channel blacks. Acetylene blacks may also be employed, as well as mixtures of two or more carbon blacks.

The carbon blacks, not treated with silica, may be present in amounts of up to 50 phr, based on the elastomer, and more preferably are employed in amounts of 1 to 35 phr, most preferably 5 to 20 phr. If a combination of such carbon black and silica is used, usually at least about 5 phr of carbon black and at least 10 phr of silica are used. For example, a weight ratio of silica to carbon black ranging from about 1/5 to 5/1 might be used.

The silica filled, sulfur-vulcanizable rubber composition in accordance with 30) the present invention will contain an amount of silica reinforcing filler and/or silica-treated carbon black reinforcing filler in the range of 5 to 100 phr, more preferably 10-90 phr, even more preferably 25-90 phr and most preferably, 40-90 phr.

The elastomer or rubber that is used is an unsaturated rubber. Preferably, the rubber is selected from the group consisting of styrene-butadiene rubber (SBR), butadiene rubber (BR), natural rubber (NR), isoprene rubber (IR), styrene rubber (SR), butadiene-isoprene rubber (BIR), butadiene-isoprene styrene rubber (BISR), isoprene-styrene rubber (ISR), and mixtures thereof, such as a blend of SBR and BR. In green tyres, typically solution polymerisation derived SBR is used as the rubber.

It is readily understood by those having skill in the art that the rubber composition would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

Examples of sulfur, which may be used in the present invention, include various types of sulfur such as powdered sulfur, precipitated sulfur and insoluble sulfur. Also, sulfur donors may be used in place of, or in addition to sulfur in order to provide the required level of sulfur during the vulcanization process. Examples of such sulfur donors include, but are not limited to, tetramethylthiuram disulfide, tetraethylthiuram disulfide, tetrabutylthiuram disulfide, tetrabenzylthiuram disulfide, dipentamethylene thiuram hexasulfide, dithiodimorpholine, capralactam disulfide, dialkylthiophosphoryl disulfide, dialkylthiophosphoryl polysulfide and mixtures thereof.

The amount of sulfur, which may be compounded with the rubber will be in the range of 0.1 to 25 parts by weight, based on 100 parts of rubber, preferably in the range of 0.2 to 8 parts by weight. The amount of sulfur donor, to be compounded with the rubber, is an amount sufficient to provide an equivalent amount of sulfur, which is the same as if sulfur itself were used.

In the composition of the invention either a single vulcanization accelerator or a mixture of accelerators can be employed. The vulcanization accelerators that can be used in accordance with the present invention are those known in the art, such as those disclosed in, for example, W. Hofmann, “Rubber Technology Handbook”, Hanser Publishers, Munich 1989.

Typical vulcanization accelerators include thiazole- and benzothiazole based accelerators, for example 2-mercaptobenzothiazole and bis(2-benzothiazolyl) disulfide, benzothiazole-2-sulfenamide based accelerators, such as N-cyclohexyl-benzothiazole-2-sulfenamide, N-tert-butyl-benzothiazole-2-sulfenamide (TBBS), N,N-dicyclohexyl-benzothiazole-2-sulfenamide, and 2-(morpholinothio)benzothiazole, thiophosphoric acid derivatives, thiurams, dithiocarbamates, diphenylguanidine (DPG), diorthotolyl guanidine, dithiocarbamyl sulfenamide, xanthates, and mixtures of one or more of these accelerators. Preferably, the vulcanization accelerator comprises a benzothiazole-2-sulfenanude. A combination of a benzothiazole-2-sulfenamide and diphenylguanidine is particularly preferred.

In the composition of the present invention, the vulcanization accelerator may be employed in an amount in the range of 0.1 to 5 phr, preferably 0.3 to 3 phr, with the range of 0.5 to 2.5 phr being further preferred.

In the rubber composition in accordance with the present invention an antidegradant can be employed, and such antidegradants are known in the art and exemplary antidegradants can be found in W. Hofinann, “Rubber Technology Handbook”, Hanser Publishers, Munich 1989 pp 268-277. The antidegradant is preferably a p-phenylenediamine, selected from the group consisting of N-isopropyl-2‘N’-phenyl-p-phenylenediamine, N-(1,3-dimethyl-butyl)-N′-phenyl-p-phenylenediamine (6PPD), N,N′-bis-(1,4-dimethyl-pentyl)-p-phenylene-diamine, N, N′-bis-(1-ethyl-3-methylpentyl)-p-phenylenediamine, N,N′-ditolyl-p-phenylenediamine, and N,N′-di-β-naphthyl-p-phenylenediamine.

The amount of antidegradant used in the composition of the invention will be in the range of 0.05 to 5 phr, preferably 0.5 to 5, within the ranges of 1 to 3 and 1 to 2 phr also being preferred.

As mentioned above, conventional rubber additives may also be included in the silica-filled, sulfur vulcanizable rubber composition in accordance with the present invention. Examples include processing oils, such as aromatic oils, tackifiers, waxes, (phenolic) antioxidants, antiozonants, pigments, e.g. titanium dioxide, resins, plasticizers, factices, vulcanization activators, such as stearic acid and zinc oxide, and fillers such as carbon black. The conventional rubber additives may be added in amounts known to the person skilled in the art of rubber compounding. As mentioned above, carbon balck may be included in the composition of the instant invention, typically in an amount of 5 to 20 phr.

Further, vulcanization inhibitors, i.e. scorch retarders, such as cyclohexylthiophthalimide, phthalic anhydride, pyromellitic anhydride, benzene hexacarboxylic trianhydride, 4-methylphthalic anhydride, trimellitic anhydride, 4-chlorophthalic anhydride, salicyclic acid, benzoic acid, maleic anhydride, citraconic anhydride, itaconic anhydride, and N-nitrosodiphenyl amine may be included in conventional, known amounts. Typical vulcanization inhibitors are known in the art and taught in W. Hofrnann, “Rubber Technology Handbook”, Hanser Publishers, Munich 1989.

In rubber compositions for specific applications, it may also be desirable to include steel cord adhesion promoters such as cobalt salts and dithiosulfates in conventional, known quantities.

In a second aspect, the present invention relates to the use of an amount of a compound of the formulae I-IV, which is effective as a silica dispersion agent in a process for the sulfur vulcanisation of a filler-reinforced elastomer.

In a third aspect the present invention relates to a vulcanizable composition including:

A) an elastomer;

B) 0.1 to 25 phr of sulfur, based on the elastomer, and/or a sufficient amount of sulfur donor to provide the equivalent of 0.1 to 25 phr of sulfur, based on the elastomer;

C) 5-100 phr of at least one reinforcing filler, based on the amount of elastomer, and

D) an effective amount of a silica dispersion agent of the formula I-IV.

Details of the sulfur vulcanisable rubber composition are described above with respect to the vulcanisation process of the present invention. A preferred sulfur vulcanizable rubber composition in accordance with the present invention comprises styrene-butadiene rubber (SBR), preferably solution SBR, 40 to 100 phr of a silica, 1.0 to 10 phr of silica dispersion agent, 0.3 to 3 phr of a vulcanization accelerator, more preferably a combination of a benzothiazole-2-sulfenamide and diphenylguanidine, and 0.1 to 5 phr of sulfur/or a sulfur donor.

In a fourth aspect, the present invention relates to a vulcanisation product produced by the vulcanisation process of the present invention.

In a fifth aspect, the present invention relates to articles of manufacture, such as tire treads, pneumatic tires, e.g., for passenger cars and trucks, and industrial rubber goods, which comprise the rubber vulcanizate obtained by vulcanizing the sulfur vulcanisable rubber composition using a process in accordance with the present invention.

The present invention may provide one or more improved properties in the processing of the vulcanizable composition, in the vulcanisation process, or in the vulcanised product. For example, improvements may be found in the Payne effect, in the Theological properties, in the Mooney Viscosity, in the hardness, in the tear strength, in the abrasion resistance, in the heat buildup, and/or the hysteresis.

The following examples are illustrative of the present invention, and should not be construed as limiting the scope of the invention in any way:

### EXAMPLES

### Examples 1-4 and Comparative Examples A-C:

Rubber compositions typical for passenger tire treads (without curatives) of Examples 1-4 are presented in Table 1, utilising silica dispersion agents in accordance to with the present invention, along with comparative examples A-C. Comparative Example A employed a composition without silane coupling agent, Comparative Example B employed 3.5 phr of a conventional silane-coupling agent, and Comparative Example C employed 5.5 phr of a conventional silane-coupling agent. Example 1 employed a reduced amount of a conventional silane coupling agent plus dodecyl benzene sulfonic acid as the silica dispersion agent. Example 2 employed only dodecyl benzene sulfonic acid as the silica dispersion agent. Examples 3 and 4 employed dodecyl benzene sulfonic acid sodium salt and dodecyl thiosulfonic acid sodium salt, respectively, as the silica dispersion agents, along with reduced amounts of a conventional silane coupling agent.

TABLE 1
Compound composition

| | Example | | | | | | |
|---|---|---|---|---|---|---|---|
| | A | B | C | 1 | 2 | 3 | 4 |
| | Control | — | — | DBSA | DBSA | DBSA-Na | DTSA-Na |
| Silane [phr] | — | 3.5 | 5.5 | 3.5 | — | 3.5 | 3.5 |
| SBR BunaVSL 5025-1 | 103.13 | 103.13 | 103.13 | 103.13 | 103.13 | 103.13 | 103.13 |
| BR Buna CB 10 | 25.00 | 25.00 | 25.00 | 25.00 | 25.00 | 25.00 | 25.00 |
| Silica Zeosil 1165 | 60.00 | 60.00 | 60.00 | 60.00 | 60.00 | 60.00 | 60.00 |
| Wax PEG 4000 | 2.59 | 2.59 | 2.59 | 2.59 | 2.59 | 2.59 | 2.59 |
| Stearic acid | 2.00 | 2.00 | 2.00 | 2.00 | 2.00 | 2.00 | 2.00 |
| ZnO Harzsiegel St. | 3.00 | 3.00 | 3.00 | 3.00 | 3.00 | 3.00 | 3.00 |
| Ar. oil Ingralen450 | 8.00 | 8.00 | 8.00 | 8.00 | 8.00 | 8.00 | 8.00 |
| 6PPD-pst | 2.00 | 2.00 | 2.00 | 2.00 | 2.00 | 2.00 | 2.00 |
| Silane TESPT | — | 3.50 | 5.50 | 3.50 | — | 3.50 | 3.50 |
| DBSA | — | — | — | 2.00 | 5.50 | — | — |
| DBSA-Na | — | — | — | — | — | 2.00 | — |
| DTSA-Na | — | — | — | — | — | — | 2.00 |

The rubber composition was mixed according to the following conventional mixing procedure:

1. First mixing (starting temperature of 30° C., cool at 90° C.)

t=0, add SBR+BR

t=1, add half silica+Si-69 (when indicated in table 1)+silica dispersion agent

t=2, add the remaining silica+oil+remaining ingredients

t=3, Sweep

t=4, dump

2. Second mixing: t=0, mix from step 1, start with 144 rpm until the temperature of the Banbury mixer reaches 125° C., reduce to 72 rpm and maintain the temperature on the clock at between 130-135° C. for 5 minutes by lifting the ram. The needle temperature is kept between 150-157° C.

3. Mill mixing: Curatives, such as accelerator and sulfur were mixed on a two-roll mill at approximately 50-70° C. according to the standard ASTM procedure.

The processing data for these examples is set forth in Table 2. Next, the rubber compositions were vulcanized by compression moulding at 170° C. for the optimum cure times as indicated in the tables. After cooling the vulcanized rubber sheets for 24 hours, test pieces were cut and their properties were determined.

TABLE 2
Processing data at 100° C.

| | Example | | | | | | |
|---|---|---|---|---|---|---|---|
| | A | B | C | 1 | 2 | 3 | 4 |
| | Control | — | — | DBSA | DBSA | DBSA-Na | DTSA-Na |
| Silane [phr] | — | 3.5 | 5.5 | 3.5 | — | 3.5 | 3.5 |
| Initial [MU] | 118 | 106 | 101 | 88 | 83 | 102 | 101 |
| ML(1 + 4) [MU] | 104 | 78 | 72 | 67 | 64 | 74 | 77 |

The interaction between filler and rubber is expressed in the form of Payne effect. The Payne effect, i.e., the decrease in storage modulus in the strain area 0.7%-25% was determined on a RPA 2000 at 100° C. and 20 cpm. The lower the Payne effect, the better the silica dispersion. The Payne effect results for Examples A-C and 1-4 are reported in Table 3.

TABLE 3
Payne effect (G′_{0.67%}-G′_{25%})

| | Example | | | | | | |
|---|---|---|---|---|---|---|---|
| | A | B | C | 1 | 2 | 3 | 4 |
| Tested prod. [phr] | Control | — | — | DBSA | DBSA | DBSA-Na | DTSA |
| Silane [phr] | — | 3.5 | 5.5 | 3.5 | — | 3.5 | 3.5 |
| G′(0.67%) | 1943 | 926 | 681 | 635 | 436 | n.d. | n.d. |
| G′(25%) | 414 | 315 | 265 | 249 | 200 | n.d. | n.d. |
| G′(0.67%)-G′(25%) | 1529 | 611 | 416 | 386 | 236 | n.d. | n.d. |

In Examples 1-4, the sulfonic acid derivatives, such as dodecyl benzene sulfonic acid (DBSA), dodecyl benzene sulfonic acid sodium salt (DBSA-Na), and dodecyl thiosulfonic acid sodium salt (DTSA-Na), are demonstrated to be a partial, as well as a total, replacement for the conventional silane coupling agent (Si-69). From the data, 20? it is clearly seen that DBSA used alone (Example 2) exhibits a better Payne effect than the conventional silane coupling agent Si-69 when used alone (Example C), as well as a processing advantage in the form of a reduced viscosity of the mixture.

### Example 5 and Comparative Examples D-E:

Additional tests, including comparisons against conventional silane coupling agent, were run using DBSA to demonstrate the application of the present invention in D so-called “Green Tire” formulations, such as are found in European Patent application publication number 0 501 227. The formulations are listed in Table 4.

TABLE 4
Compound composition

| | | | |
|---|---|---|---|
| BR Buna CB 10 | 25 | 25 | 25 |
| Silica Zeosil 1165 | 80 | 80 | 80 |
| Wax PEG 4000 | 2.6 | 2.6 | 2.6 |
| Stearic acid | 2 | 2 | 2 |
| Zinc Oxide HS | 3 | 3 | 3 |
| Ar. Oil Ingralen 450 | 8 | 8 | 8 |
| 6PPD | 2 | 2 | 2 |
| Silane TESPT | 0 | 5.5 | 0 |
| DTSA | 0 | 0 | 5.5 |
| TBBS | 1.7 | 1.7 | 1.7 |
| DPG | 2 | 2 | 2 |
| Sulfur | 1.5 | 1.5 | 1.5 |

Processing data @ 100C.

The mixing procedures were those described above for Examples 1-4 and Comparative Examples A-C. The processing data are reported in Table 5.

TABLE 5
Processing data at 100° C.

| | Example | | |
|---|---|---|---|
| | D | E | 5 |
| | Blank | Si-69 | DBSA |
| Initial, MU | >200 | 185 | 95 |
| ML(1 + 4), MU | — | 135 | 75 |

The vulcanized rubber compositions were evaluated for their Payne effect, as well as other physical and dynamic properties, including rheological properties, Mooney Viscosity, hardness, and dynamic mechanical properties. The results are reported in Tables 6-10.

The rheological properties were determined on a Monsanto Rheometer MDR 2000E, are 0.5 degrees, 170° C./60 min. Scorch time (Ts2) is the time to increase the torque 2 dNm above the minimum torque (ML). Optimum vulcanization time (t90) is the time at 90% of the maximum torque (MH). Delta torque (Delta S) is the difference between the maximum and the minimum torque. The Mooney Viscosity, ML(1+4) was determined for the masterbatch by using Mooney Viscometer at 100° C. Hardness, stress-strain properties, tear strength and abrasion resistance were determined following the procedure as indicated:

| | |
|---|---|
| Hardness: | ISO 48 |
| Stress-strain: | ISO 37 |
| Tear strength: | ISO 34/1 |
| Abrasion (DIN): | DIN 4949 |

Heat build-up (HBU) measurements were carried out in accordance with ASTM D 623/A (Load: 10.8 Kg; Stroke: 4.45 mm; Duration: 30 min; start temperature: 100° C.). The dynamic mechanical properties were determined using a Metravib R.D.S viscoanalyzer (deformation type: tension-compression; temperature: 60° C.; Frequency: 15 Hz and DSA: 2%). Hysteresis (tangent delta) is the percentage energy loss per cycle of deformation.

TABLE 6
Payne effect (G′_{0.67%} − G′_{25%})

| | Example | | |
|---|---|---|---|
| | D | E | 5 |
| | Blank | Si-69 | DBSA |
| G′(0.67%) | 8145 | 3328 | 2012 |
| G′(25%) | 757 | 468 | 255 |
| Payne effect | 7388 | 2860 | 1757 |

TABLE 7
Rheological data at 170° C.

| | Example | | |
|---|---|---|---|
| | D | E | 5 |
| | Blank | Si-69 | DBSA |
| Delta S, Nm | 4.55 | 2.26 | 2.25 |
| Ts2, min | 1.5 | 1.1 | 1.3 |
| T90, min | 8 | 9.2 | 7.5 |

TABLE 8
Mechanical properties (170° C./t90)

Example

| | D | E | 5 |
|---|---|---|---|
| Cure: 170 C/t90 | Blank | Si-69 | DBSA |
| Hardness, IRHD | 98 | 80 | 79 |
| M100, Mpa | 1.7 | 3 | 2.9 |
| M300, Mpa | 8.5 | 11.8 | 11.6 |
| Tensile, Mpa | 10.3 | 17.9 | 18.5 |
| Elongation, % | 380 | 450 | 470 |
| Tear, kN/m | 25 | 60 | 70 |
| Abrasion loss, mm3 | 180 | 120 | 110 |

TABLE 9
Heat Build Up at 100° C. in 1 hour

Example

| | D | E | 5 |
|---|---|---|---|
| Cure: 170 C/t90 | Blank | Si-69 | DBSA |
| Temp., delta T, C | 48 | 36 | 33 |
| Permanent set, % | 10 | 6 | 5 |

TABLE 10
Viscoelastic properties (Cure: 170° C./t90)

Example

| | D | E | 5 |
|---|---|---|---|
| Cure: 170 C/t90 | Blank | Si-69 | LAS |
| E′, Mpa | 7.3 | 11.5 | 11.6 |
| E″, Mpa | 1.87 | 1.37 | 1.3 |
| Tangent delta | 0.256 | 0.119 | 0.112 |

From the data shown in Tables 6-10, it is evident that DBSA alone can replace a conventional silane coupling agent in a Green tire tread formulation with identical to improved processing parameters (lower t90 and better scorch properties, Table 7), as well as providing at least equivalent performance characteristics in the resultant product.

### Examples 6-10

The use of long chain alkyl multihydroxy amides, such as 2,3,4,5,6 pentahydroxy hexanoic acid octylamide (PHAOA), 2,3,4,5,6 pentahydroxy hexanoic acid octadecylamide (PHAODA), and 2,3,4,5,6 pentahydroxy hexanoic acid dodecylamide (PHADA) were evaluated as partial or full replacement of silane coupling agent, Si-69 in SBR tire compositions. The formulations are listed in Table 11.

TABLE 11
Compound composition

| | Example | | | | | | | |
|---|---|---|---|---|---|---|---|---|
| | A | B | C | 6 | 7 | 8 | 9 | 10 |
| S-SBR* | 103 | 103 | 103 | 103 | 103 | 103 | 103 | 103 |
| BR^{#} | 25 | 25 | 25 | 25 | 25 | 25 | 25 | 25 |
| Silica^{$} | 60 | 60 | 60 | 60 | 60 | 60 | 60 | 60 |
| Wax | 2.6 | 2.6 | 2.6 | 2.6 | 2.6 | 2.6 | 2.6 | 2.6 |
| Stearic acid | 2 | 2 | 2 | 2 | 2 | 2 | 2 | 2 |
| Zinc oxide | 3 | 3 | 3 | 3 | 3 | 3 | 3 | 3 |
| Ar. Oil | 8 | 8 | 8 | 8 | 8 | 8 | 8 | 8 |
| 6PPD | 2 | 2 | 2 | 2 | 2 | 2 | 2 | 2 |
| TESPT | 0 | 3.5 | 5.5 | 3.5 | 0 | 3.5 | 0 | 3.5 |
| SMO | 0 | 0 | 0 | 0 | 0 | 0 | 0 | 0 |
| PHAOA | 0 | 0 | 0 | 2.0 | 5.5 | 0 | 0 | 0 |
| PHADA | 0 | 0 | 0 | 0 | 0 | 2.0 | 5.5 | 0 |
| PHAODA | 0 | 0 | 0 | 0 | 0 | 0 | 0 | 2.0 |

*SBR used is S-SBR Buna VSL 5025-1,
^{#}BR is BR Buna CB 10 and Silica is Zeosil 1165.

The compositions were processed in accordance with the previously noted conventional mixing procedure. The processing data is noted in Table 12.

TABLE 12
Processing data at 100° C.

| | Example | | | | | | | |
|---|---|---|---|---|---|---|---|---|
| | A | B | C | 6 | 7 | 8 | 9 | 10 |
| Initial, MU | 118 | 106 | 101 | 86 | 82 | 86 | 84 | 88 |
| ML(1 + 4), MU | 104 | 78 | 72 | 66 | 62 | 67 | 64 | 70 |

The vulcanized rubber compositions were evaluated for their Payne effect, and the results are reported in Tables 13.

TABLE 13
Payne effect (G′_{0.67%} − G′_{25%})

| | Example | | | | | | | |
|---|---|---|---|---|---|---|---|---|
| | A | B | C | 6 | 7 | 8 | 9 | 10 |
| G′ (0.67%) | 1943 | 926 | 681 | 482 | 405 | Nd | 551 | Nd |
| G′(25%) | 414 | 315 | 265 | 223 | 199 | Nd | 219 | Nd |
| G′(0.67%) − | 1529 | 611 | 416 | 259 | 206 | Nd | 332 | Nd |
| G′(25%) | | | | | | | | |

*Nd = Not determined

It is very clear from the data in Tables 12 and 13, that long chain alkyl multihydroxy amides PHAOA, PHADA and PHAODA are capable of partial, as well as total replacement of the conventional silane coupling agent, Si-69 in highly silica-filled rubber compounds. The processing data (Mooney viscosity) is improved by this invention. Additionally it shows positive effect on “Payne effect”.

### Examples 11-12

The use of long chain alkyl maleic/succinic, citraconic acid amides is shown in the SBR compositions reported in Table 14. The compositions were processed as noted earlier, cured and tested for their “Payne effect”. The silica dispersion agents that were tested were N-dodecyl maleic acid (N-DMA) and N-octadodecyl maleic acid (N-ODMA). The vulcanized compositions were evaluated against Comparative Examples A-C to determine whether N-DMA and N-ODMA can totally or partially replace a conventional silane coupling agent. The processing data is reported in Table 15, while the Payne effect is reported in Table 16.

TABLE 14
Compound composition

| | Example | | | | |
|---|---|---|---|---|---|
| | A | B | C | 11 | 12 |
| Tested product | Control | — | — | N-DMA | N-ODMA |
| Silane [phr] | — | 3.5 | 5.5 | 3.5 | 3.5 |
| SBR BunaVSL 5025-1 | 103.13 | 103.13 | 103.13 | 103.13 | 103.13 |
| BR Buna CB 10 | 25.00 | 25.00 | 25.00 | 25.00 | 25.00 |
| Silica Zeosil 1165 | 60.00 | 60.00 | 60.00 | 60.00 | 60.00 |
| Wax PEG 4000 | 2.59 | 2.59 | 2.59 | 2.59 | 2.59 |
| Stearic acid | 2.00 | 2.00 | 2.00 | 2.00 | 2.00 |
| ZnO Harzsiegel St. | 3.00 | 3.00 | 3.00 | 3.00 | 3.00 |
| Ar. oil Ingralen450 | 8.00 | 8.00 | 8.00 | 8.00 | 8.00 |
| 6PPD-pst | 2.00 | 2.00 | 2.00 | 2.00 | 2.00 |
| Silane TESPT | — | 3.50 | 5.50 | 3.50 | 3.50 |
| N-DMA | — | — | — | 2.00 | — |
| N-ODMA | — | — | — | — | 2.00 |

TABLE 15
Processing data at 100° C.

| | Example | | | | |
|---|---|---|---|---|---|
| | A | B | C | 11 | 12 |
| | Blank | Si-69 | Si-69 | N-DMA | N-ODMA |
| Silane [phr] | — | 3.5 | 5.5 | 3.5 | 3.5 |
| Initial [MU] | 118 | 106 | 101 | 85 | 90 |
| ML(1 + 4) [MU] | 104 | 78 | 72 | 64 | 68 |

TABLE 16
Payne effect (G′_{0.67%} − G′_{25%})

| | Example | | | | |
|---|---|---|---|---|---|
| | A | B | C | 11 | 12 |
| | | Si-69 | Si-69 | N-DMA | N-ODMA |
| Silane [phr] | — | 3.5 | 5.5 | 3.5 | 3.5 |
| G′(0.67%) | 1943 | 926 | 681 | 451 | 497 |
| G′(25%) | 414 | 315 | 265 | 211 | 206 |
| G′(0.67%) − G′(25%) | 1529 | 611 | 416 | 240 | 291 |

It is clear from the data as shown in Tables 15 and 16, that long alkyl containing acid amides are capable of partial replacement of silane coupling agent, Si-69 with better processing data (see Mooney viscosity, Table 15) and improved polymer filler interaction (Payne effect, Table 16).

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled D in the art to best utilize the invention in its various embodiments and with various modifications as are suited to the particular use contemplated. It is intended that the invention be defined by the following claims.

What we claim is:

1. A process for the preparation of a vulcanised elastomeric compound comprising the steps of providing a composition which contains an elastomer, from about 5 to about 100 phr of reinforcing filler selected from the group consisting of silicas and silica-treated carbon blacks, based on the amount of elastomer, from about 0.1 to about 25 phr of sulfur and/or a sufficient amount of sulfur donor to provide the equivalent of 0.1 to 25 phr of sulfur, based on the amount of elastomer, and an effective amount of a silica dispersion agent, wherein the silica dispersion agent comprises a compound selected from the group consisting of:
a) compounds of the formula I:
R-A-SO₃M (I)
wherein R is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, C₇-C₃₀ alkylthioaryl groups;
A is selected from nothing, a group —O—B, wherein B is a polyoxyalkylene group wherein the average number of oxyalkytene groups is in the range of from about 0.5 to about 30, and an ester group of the formula: 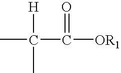
wherein R₁ is a C₁-C₆ hydrocarbyl group; and
M is selected from hydrogen, and a cation selected from an alkali metal, an alkaline earth metal, ammonium, alkyl-substituted ammonium, and an alkanolamine group having 1 to 3 alkanol groups, wherein each alkanol group has 2 or 3 carbon atoms;
b) a polyhydroxy fatty acid amide of the formula II: 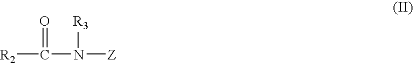
wherein R₂ is selected from hydrogen, C₁-C₁₀ hydrocarbyl, 2-hydroxy ethyl, 2-hydroxy propyl, methoxy ethyl, methoxy propyl or a mixture thereof, R₃ is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, and C₇-C₃₀ alkylthioaryl groups; and Z is a polyhydroxyhydrocarbyl having a linear hydrocarbyl chain with at least three hydroxy groups directly connected to the linear hydrocarbyl chain, or an alkoxylated polyhydroxyhydrocarbyl having a linear hydrocarbyl chain with at least three hydroxy groups directly connected to the linear hydrocarbyl chain; and
d) a compound of the formulae III and IV: 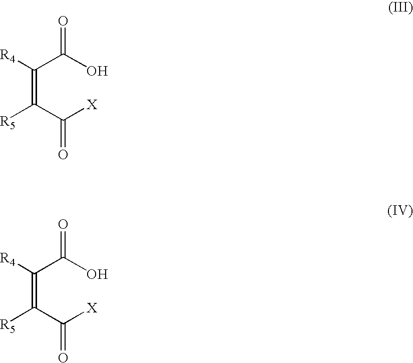
wherein R₄ and R₅ are independently selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, and X is selected from the group consisting of —OH and —NH—R₆, wherein R₆ is selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups; and vulcanising the composition.

2. The process according to claim 1, wherein silica dispersion agent is present in an amount in the range of 0.5 to 10 phr.

3. The process according to claim 2, wherein the silica dispersion agent comprises a compound selected from the group consisting of dodecyl benzene sulfonic acid and its salts; dodecyl thiosulfonic acid and its salts; 2,3,4,5,6 pentahydroxy hexanoic acid octadecylamide; 2,3,4,5,6 pentahydroxy hexanoic acid octylamide; 2,3,4,5,6 pentahydroxy hexanoic acid dodecylamide; N-dodecyl maleic acid; and N-octyldodecyl maleic acid.

4. The process according to claim 2, wherein the silica dispersion agent comprises a compound selected from the group consisting of dodecyl benzene sulfonic acid, dodecyl benzene sulfonic acid sodium salt, dodecyl thiosulfonic acid, and dodecyl thiosulfonic acid sodium salt.

5. The process according to claim 2, wherein the silica dispersion agent comprises dodecyl benzene sulfonic acid.

6. The process according to claim 1, wherein the rubber is selected from the group consisting of styrene-butadiene rubber, butadiene rubber, isoprene rubber, and mixtures thereof.

7. The process according to claim 1 wherein the reinforcing filler is present in an amount of 20 to 100 phr.

8. An article of manufacture comprising a vulcanized rubber article made by the process of claim 1.

9. An article of manufacture comprising a vulcanised rubber article made by the process of claim 4.

10. An article of manufacture comprising a tire, wherein at least a tread of the tire comprises the rubber vulcanizate obtained by the process according to claim 1.

11. An article of manufacture comprising a tire, wherein at least a tread of the tire comprises a rubber vulcanizate obtained by the process according to claim 3.

12. An article of manufacture comprising a tire, wherein at least a tread of the tire comprises a rubber vulcanizate obtained by the process according to claim 4.

13. An article of manufacture comprising a tire, wherein at least a tread of the tire comprises a rubber vulcanizate obtained by the process according to claim 5.

14. A sulfur vulcanized, silica filled rubber composition, comprising a compound selected from the group consisting of:
a) compounds of the formula I:
R-A-SO₃M (I)
wherein R is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, C₇-C₃₀ alkylthioaryl groups;
A is selected from nothing, a group —O—B, wherein B is a polyoxyalkylene group wherein the average number of oxyalkylene groups is in the range of from about 0.5 to about 30, and an ester group of the formula: 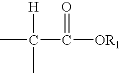
wherein R₁ is a C₁-C₆ hydrocarbyl group; and
M is selected from hydrogen, and a cation selected from an alkali metal, an alkaline earth metal, ammonium, alkyl-substituted ammonium, and an alkanolamine group having 1 to 3 alkanol groups, wherein each alkanol group has 2 or 3 carbon atoms;
b) a polyhydroxy fatty acid amide of the formula II: 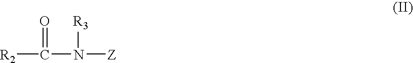
wherein R₂ is selected from hydrogen, C₁-C₁₀ hydrocarbyl, 2-hydroxy ethyl, 2-hydroxy propyl, methoxy ethyl, methoxy propyl or a mixture thereof, R₃ is selected 2.5 from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, and C₇-C₃₀ alkylthioaryl groups; and Z is a polyhydroxyhydrocarbyl having a linear hydrocarbyl chain with at least three hydroxy groups directly connected to the linear hydrocarbyl chain, or an alkoxylated polyhydroxyhydrocarbyl having a linear hydrocarbyl chain with at least three hydroxy groups directly connected to the linear hydrocarbyl chain; and
c) a compound of the formulae III and IV: 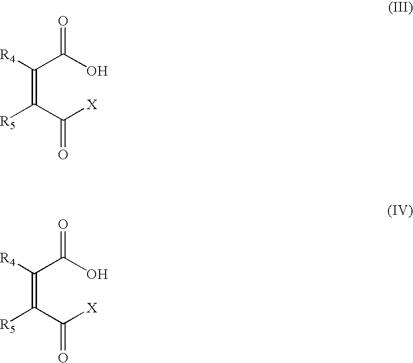
wherein R₄ and R₅ are independently selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, and X is selected from the group consisting of —OH and —NH—R₆, wherein R₆ is selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups; as a silica dispersion agent.

15. A sulfur vulcanized, silica filled rubber composition as claimed in claim 14, wherein the silica dispersion agent comprises a compound selected from the group consisting of dodecyl benzene sulfonic acid and its salts; dodecyl thiosulfonic acid and its salts; 2,3,4,5,6 pentahydroxy hexanoic acid octadecylamide; 2,3,4,5,6 pentahydroxy hexanoic acid octylamide; 2,3,4,5,6 pentahydroxy hexanoic acid dodecylamide; N-dodecyl maleic acid; and N-octyldodecyl maleic acid.

16. A sulfur vulcanised, silica filled rubber composition as claimed in claim 14, wherein the silica dispersion agent comprises a compound selected from the group consisting of dodecyl benzene sulfonic acid, dodecyl benzene sulfonic acid sodium salt, dodecyl thiosulfonic acid, and dodecyl thiosulfonic acid sodium salt.

17. A sulfur vulcanised, silica filled rubber composition as claimed in claim 14, wherein the silica dispersion agent comprises dodecyl benzene sulfonic acid.

18. A vulcanized rubber composition, which comprises the vulcanization reaction product of:
A) 100 parts of at least one natural or synthetic rubber or blends;
B) 0.1 to 25 phr of sulfur and/or a sufficient amount of sulfur donor to provide an equivalent of 0.1 to 25 parts by weight of sulfur;
C) 0 to 5 phr of a vulcanization accelerator;
D) 0 to 5 phr of antidegradant;
E) 10-100 parts by weight of at least one reinforcing filler selected from the group consisting of silicas and silica-treated carbon blacks; and
F) 0.1 to 25 parts by weight of at least one silica dispersion agent selected from the group consisting of:
a) compounds of the formula I:
R-A-SO₃M (I)
wherein R is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, C₇-C₃₀ alkylthioaryl groups;
A is selected from nothing, a group —O—B, wherein B is a polyoxyalkylene group wherein the average number of oxyalkylene groups is in the range of from about 0.5 to about 30, and an ester group of the formula: 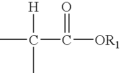
wherein R₁ is a C₁-C₆ hydrocarbyl group; and
M is selected from hydrogen, and a cation selected from an alkali metal, an alkaline earth metal, ammonium, alkyl-substituted ammonium, and an alkanolamine group having 1 to 3 alkanol groups, wherein each alkanol group has 2 or 3 carbon atoms;
b) a polyhydroxy fatty acid amide of the formula II: 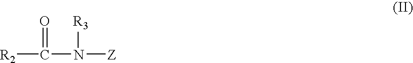
wherein R₂ is selected from hydrogen, C₁-C₁₀ hydrocarbyl, 2-hydroxy ethyl, 2-hydroxy propyl, methoxy ethyl, methoxy propyl or a mixture thereof, R₃ is selected from C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, C₁-C₂₀ thioalkyl groups, C₃-C₂₀ cyclothioalkyl groups, C₆-C₂₀ thioaryl groups, C₇-C₃₀ arylthioalkyl groups, and C₇-C₃₀ alkylthioaryl groups; and Z is a polyhydroxyhydrocarbyl having a linear hydrocarbyl chain with at least three hydroxy groups directly connected to the linear hydrocarbyl chain, or an alkoxylated polyhydroxyhydrocarbyl having a linear hydrocarbyl chain with at least three hydroxy groups directly connected to the linear hydrocarbyl chain; and
c) a compound of the formulae III and IV: 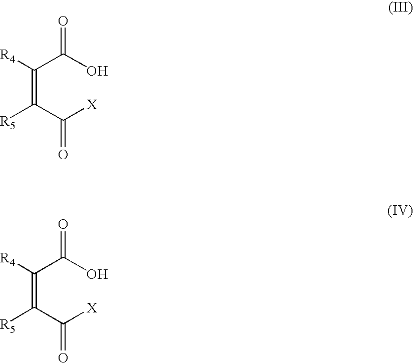
wherein R₄ and R₅ are independently selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups, and X is selected from the group consisting of —OH and —NH—R₆, wherein R₆ is selected from the group consisting of hydrogen, C₁-C₂₀ alkyl groups, C₃-C₂₀ cycloalkyl groups, C₆-C₂₀ aryl groups, C₇-C₃₀ aralkyl groups, C₇-C₃₀ alkaryl groups, C₁-C₂₀ alkenyl groups.

19. A vulcanized rubber composition as claimed in claim 18, wherein the silica dispersion agent comprises a compound selected from the group consisting of dodecyl benzene sulfonic acid and its salts; dodecyl thiosulfonic acid and its salts; 2,3,4,5,6 pentahydroxy hexanoic acid octadecylamide; 2,3,4,5,6 pentahydroxy hexanoic acid octylamide; 2,3,4,5,6 pentahydroxy hexanoic acid dodecylamide; N-dodecyl maleic acid; and N-octyldodecyl maleic acid.

20. A vulcanised rubber composition as claimed in claim 19, wherein the silica dispersion agent comprises a compound selected from the group consisting of dodecyl benzene sulfonic acid, dodecyl benzene sulfonic acid sodium salt, dodecyl thiosulfonic acid, and dodecyl thiosulfonic acid sodium salt.
